(19) United States
(12) Patent Application Publication
(10) Pub. No.: US 2024/0253513 A1
(43) Pub. Date: Aug. 1, 2024

(54) NETWORK OF ELECTRIC VEHICLE MOBILE CHARGING STATIONS

(71) Applicant: Jimmy Visbal, Sunrise, FL (US)

(72) Inventor: Jimmy Visbal, Sunrise, FL (US)

(21) Appl. No.: 18/623,520

(22) Filed: Apr. 1, 2024

Related U.S. Application Data
(60) Provisional application No. 63/482,639, filed on Feb. 1, 2023.

(51) Int. Cl. B60L 53/66; G06Q 50/06; H04L 9/40

(52) U.S. Cl. CPC B60L 53/665; G06Q 50/06; H04L 63/0838

(57) ABSTRACT

A method includes receiving a charging request for a user device. The method includes broadcasting a supplier request to a plurality of supplier devices. The method also includes receiving a supplier acceptance from a supplier device from the plurality of supplier devices. The method includes transmitting an acceptance notification to the user device. The method further includes generating a one-time access token, where the one-time access token provides access to a charging target during a charging service. The method includes providing the one-time access token to the supplier device.

### CROSS-REFERENCE TO RELATED APPLICATIONS

This application claims the benefit of priority of U.S. provisional application No. 63/482,639, filed Feb. 1, 2023, titled “Network of Electric Vehicle Mobile Charging Stations,” the entire contents of which are herein incorporated by reference.

### FIELD

The present invention relates to electric vehicle mobile charging stations and, more particularly, to a network therefor.

### BACKGROUND

Electric vehicles are increasingly popular. However, charging stations for electric vehicles are not readily available. It is difficult to find a charging station as they are available in limited locations. Currently, there are no methods or processes for swift and easy charging of a mobile vehicle on demand in a convenient fashion. There are also no networks or apps available for users to summon or call someone capable of charging their vehicle.

As can be seen, there is a need for a network that can provide electric vehicle drivers with a quick, convenient, and easy way to charge their electric vehicles on demand.

### SUMMARY

In one aspect of the present disclosure, a method for delivering portable charging includes receiving a charging request for a user device. The method includes broadcasting a supplier request to a plurality of supplier devices. The method also includes receiving a supplier acceptance from a supplier device from the plurality of supplier devices. The method includes transmitting an acceptance notification to the user device. The method further includes generating a one-time access token, where the one-time access token provides access to a charging target during a charging service. The method includes providing the one-time access token to the supplier device.

In another aspect of the present disclosure, a computer-readable medium stores instructions for causing one or more processors to perform a method. The method receiving a charging request for a user device. The method includes broadcasting a supplier request to a plurality of supplier devices. The method also includes receiving a supplier acceptance from a supplier device from the plurality of supplier devices. The method includes transmitting an acceptance notification to the user device. The method further includes generating a one-time access token, where the one-time access token provides access to a charging target during a charging service. The method includes providing the one-time access token to the supplier device.

In another aspect of the present disclosure, a system includes one or more memory devices storing instructions and one or more processors. The one or more processors are configured to execute the instructions to perform a method. The method receiving a charging request for a user device. The method includes broadcasting a supplier request to a plurality of supplier devices. The method also includes receiving a supplier acceptance from a supplier device from the plurality of supplier devices. The method includes transmitting an acceptance notification to the user device. The method further includes generating a one-time access token, where the one-time access token provides access to a charging target during a charging service. The method includes providing the one-time access token to the supplier device.

### BRIEF DESCRIPTION OF THE DRAWINGS

FIG. 1 is a diagram of an environment 100 including a charge broker system 102, according to aspects of the present disclosure;

FIG. 2 is a block diagram of the environment 100 including a charge broker system 102, according to aspects of the present disclosure;

FIG. 3 is a flow diagram of an overall process performed by the charge broker system 102, according to aspects of the present disclosure; and

FIG. 4 is a flow diagram of a charging process performed by the charge broker system 102, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Broadly, embodiments of the present disclosure provide a system and method for charging electric vehicles. The system and method may provide a network for mobile electric vehicle charging. The network enables a user to bring a mobile charging station to their vehicle at their convenience, anywhere, anytime. A user may utilize an app on a smartphone or another wireless device. The user (a consumer) may input a time and location, automatically or manually, into the app. The app may join the user with a provider available at the time and location. The provider may then access the user's vehicle and charge the vehicle. The network may be accessed nationwide and may be especially useful in remote areas. The network may be utilized in emergency situations or for roadside service. Alternatively, the network may be utilized in populated areas, such as a mall, restaurant, or theatre. The system and method may function similarly to an UBER service where providers may be independent contractors. The system and method may provide work to individuals with a vehicle, a generator and inverter, and a charging adapter to provide customers with charging at any location. The system and method may work with Android, iPhone & Microsoft app-based w/GPS enabled. In some embodiments, all fees may be processed through the app, making transactions cash-free.

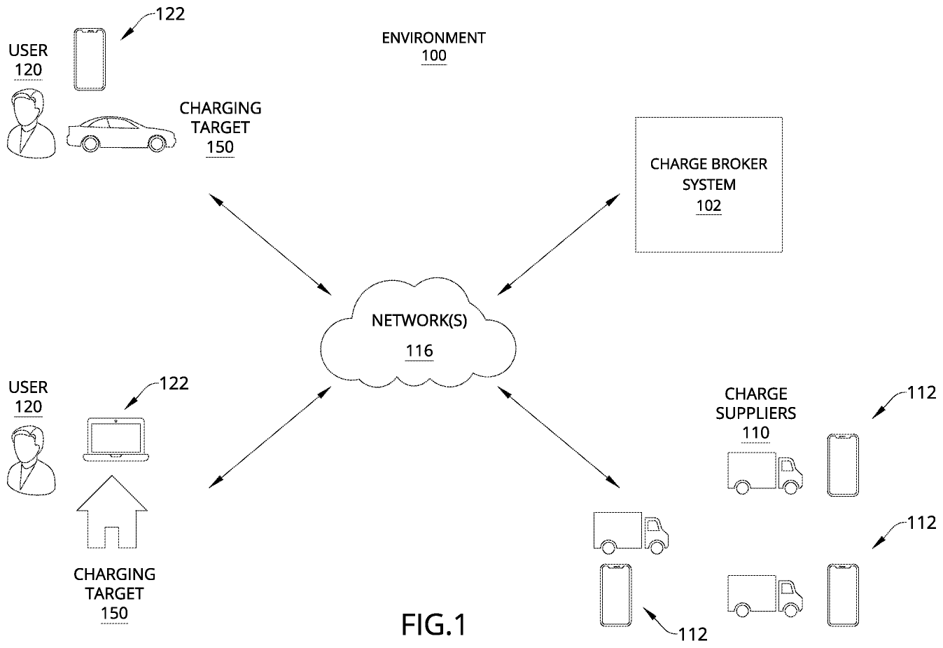

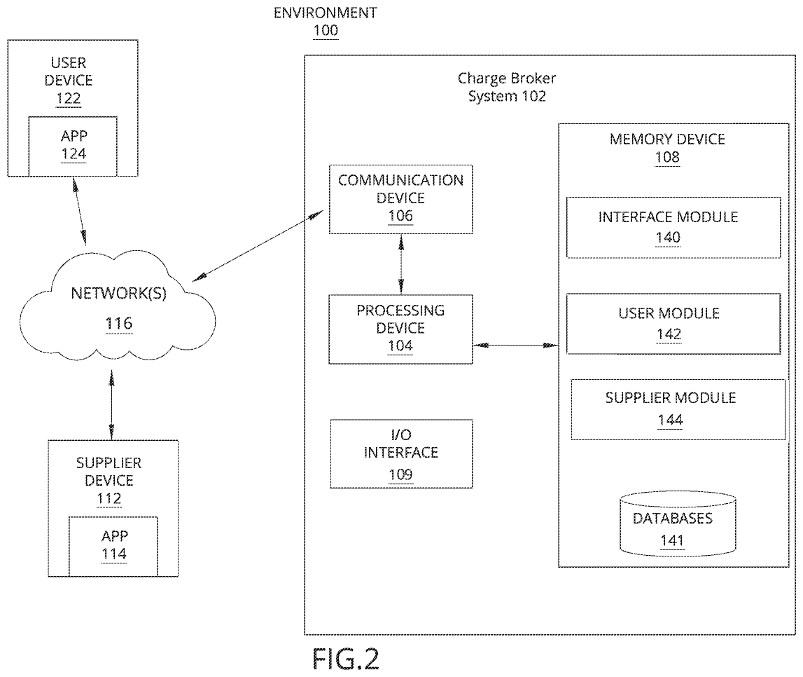

Referring now to FIGS. 1-4, FIGS. 1 and 2 illustrate an environment 100 including a charge broker system 102, according to aspects of the present disclosure. While FIGS. 1 and 2 illustrate examples of components of environment 100 and the charge broker system 102, additional components can be added and existing components can be removed and/or modified.

As illustrated in FIG. 1, environment 102 can represent a network entity that desires to provide and receive charging services. As described herein “charging services” refers to power services being provided by a portable power supply to one or more charging targets. For example, charging services can include charging an electric vehicle. In another example, charging services can include providing power to a structure and/or electrical system. In any of the examples, the charging services are provided by a mobile power supply vehicle, which includes the necessary hardware and software to provide the charging services, such as one or more vehicles that transport a power source (e.g., one or more generators, one or more batteries, one or more solar panels, etc.), electrical connections and adaptors, and hardware/software for controlling the charging process.

As illustrated, the charge broker system 102 operates to facilitate the exchange of charging services between one or more charge suppliers 110 and one or more users 120 having charging targets 150. The charge broker system 102 can communicate with supplier devices 112 of the one or more suppliers 100 via one or more networks 116. Likewise, the charge broker system 102 can communicate with user devices 122 of the one or more users 120 via one or more networks 116.

As illustrated in FIG. 2, the charge broker system 102 includes a processing device 104 coupled to a communication device 106. The processing device 104 is also coupled to a memory device 108, and an input/output (“I/O”) interface 109. In embodiments, the communication interface 104 enables the charge broker system 102 to communicate with other devices and systems via one or more networks 116. The charge broker system 102 can communicate with a user 120, operating a user device 122, via the one or more networks 116. The charge broker system 102 can communicate with a supplier 110, operating a supplier device 112, via the one or more networks 116. The user device 120 and/or the supplier device 112 can include one or more electronic devices such as a laptop computer, a desktop computer, a tablet computer, a smartphone, a thin client, and the like.

According to the aspects of the present disclosure, the user device 122 can store and execute a copy of a user application 124. The user application 124 enables the user 120 operating the user device 122, to communicate with the charge broker system 102 and request charging services. The supplier device 112 can store and execute a copy of a supplier application 114. The supplier application 114 enables the supplier 110 operating the supplier device 112, to communicate with the charge broker system 102 and receive request charging services. In some embodiments, the user application 124 and/or the supplier application 114 can be a specifically designed application that operates with the charge broker system 102 to perform the processes and methods described herein. In some embodiments, the user application 124 and/or the supplier application 114 can be a third-party application, such as a web browser, that communicates with the charge broker system 102 to perform the processes and methods described herein.

To perform the process described herein, the charge broker system 102 can store and execute an interface module 140, a user module 142, and a supplier module 144 to perform the processes and methods described herein. The interface module 140, the user module 142, and the supplier module 144 can be stored in the memory device 108. The user application 124, the supplier application 114, the interface module 140, the user module 142, and the supplier module 144 can include the necessary logic, instructions, and/or programming to perform the processes and methods described herein. The user application 124, the supplier application 114, the interface module 140, the user module 142, and the supplier module 144 can be written in any programming language.

The memory device 108 can also include a database 141 that stores information and data associated with the process and methods described herein. The database 141 can store information about the users 120 and information about the suppliers 110. The database 141 can be any type of database, for example, a hierarchical database, a network database, an object-oriented database, a relational database, a non-relational database, an operational database, and the like.

The interface module 140 operates to generate and provide graphical user interfaces (GUIs) to the user application 124 and/or the supplier application 114, for example, menus, widgets, text, images, fields, etc. Additionally, the interface module 140 can provide data to the user application 124 and/or the supplier application 114, and the user application 124 and/or the supplier application 114 can generate GUIs. The GUIs generated by the interface module 140, the user application 124 and/or the supplier application 114 can be interactive. For example, the GUIs can allow the user 120 of the user devices 122 to request charging services. The user module 142 operates to control and facilitate all processes associated with the user application 124, as described below. The supplier module 144 operates to control and facilitate all processes associated with the supplier application 114, as described below.

The processing device 104, the communication device 106, the memory device 108, and the I/O interface 110 can be interconnected via a system bus. The system bus can be and/or include a control bus, a data bus, an address bus, and the like. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the charge broker system 102 can include multiple processing devices 104, whether the same type or different types.

The memory device 108 can be and/or include one or more computerized storage media capable of storing electronic data temporarily, semi-permanently, or permanently. The memory device 108 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 108. While FIG. 1 illustrates a single memory device 108, the charge broker system 102 can include multiple memory devices 108, whether the same type or different types.

The communication device 104 enables the charge broker system 102 to communicate with other devices and systems. The communication device 104 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The charge broker system 102 can communicate with one or more network resources via the network 116. The one or more network resources can include external databases, social media platforms, search engines, file servers, web servers, or any type of computerized resource that can communicate with the charge broker system 102 via the network 116.

In embodiments, the components and functionality of the charge broker system 102 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the charge broker system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the charge broker system 102, the supplier device 112, and/or the user device 120 can include a user interface for outputting information in a format perceptible by a user and receiving input from the user. For example, the charge broker system 102 can communicate with the user interface via the I/O interface 112. In another example, the supplier device 112 can include the user interface for providing information to and receiving information from the supplier 110. In another example, the user device 122 can include the user interface for providing information to and receiving information from the user 120. The user interface can display graphical user interfaces (“GUIs”) generated by the charge broker system 102, the supplier application 114, and/or the user application 124. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

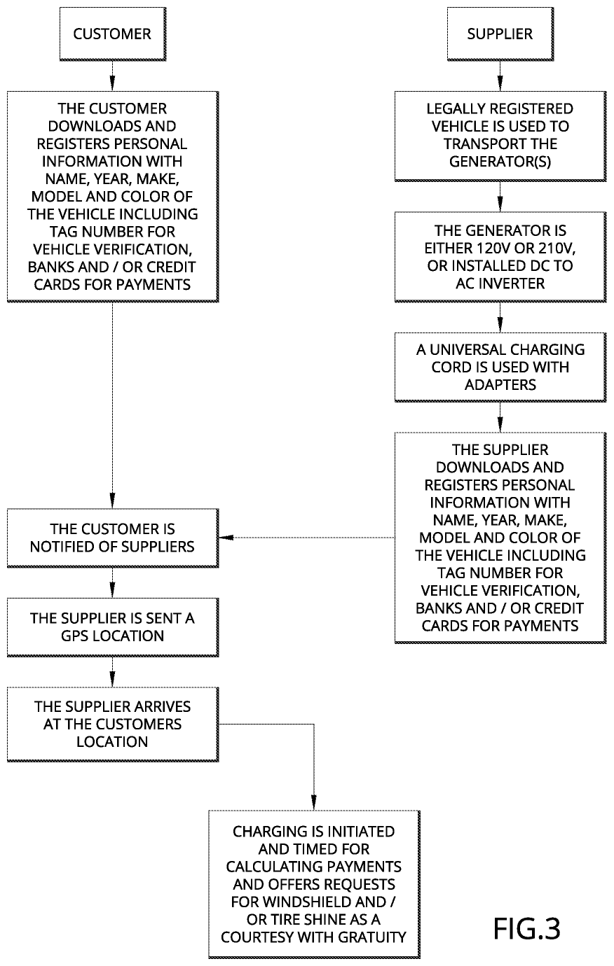

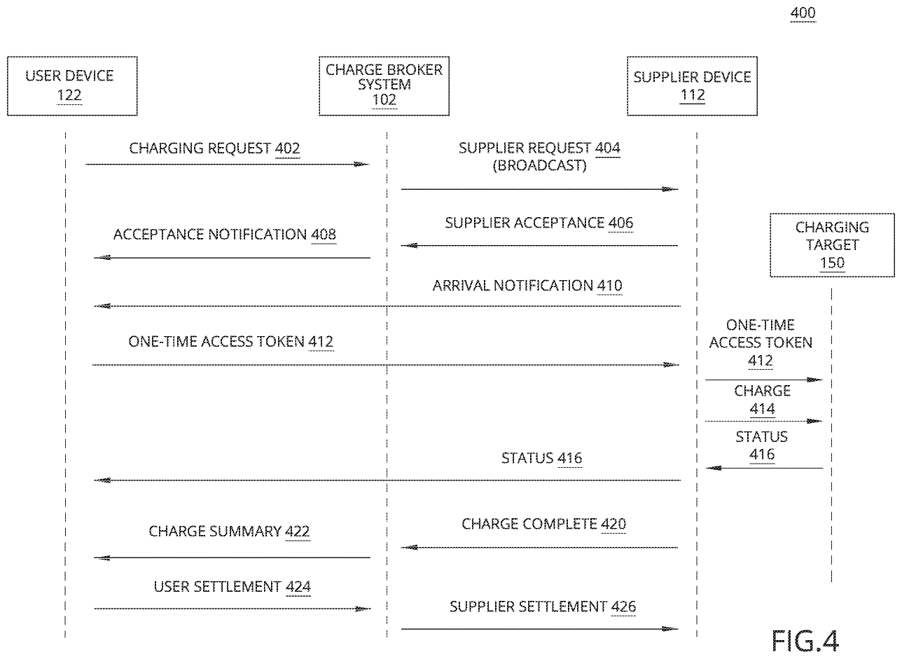

FIGS. 3 and 4 illustrate overall process and a method 400 for using the charge broker system 102 to request a vehicle charge, according to aspects of the present disclosure. While FIGS. 1 and 2 illustrate examples of stages of a method 400, additional stages can be added and existing stages can be removed, rearranged, and/or modified.

As illustrated in FIG. 3, the overall process can begin with the customer, e.g., user 120, registering with the charge broker system 102. For example, the customer can download the charging application 124 and register. The registration can include providing information such as personal information (e.g., name, address, etc.), details of the vehicle (e.g., make, model, year, color, vehicle registration, etc.), and payment information.

For the supplier (e.g., charge suppliers 110), the supplier can register with the charge broker system 102. For example, the supplier can download the charging application 124 and register. The registration can include providing information such as personal information (e.g., name, address, etc.), details of the vehicle (e.g., make, model, year, color, vehicle registration, etc.), and information for receiving payment. The supplier can also verify that they are legally registered to provide the service according to the appropriate jurisdiction. Additionally, the supplier can also verify that they have the appropriate equipment for operating as a chare supplier.

After a customer is registered, the customer can utilize the application 124 to request charging service. Generally, the process can include requesting via the application 124 charging. The customer can be provided with a list of suppliers. The customer can request service either generally or a specific charger. Once a supplier is selected, the supplier is sent a geographic (GPS) location of the vehicle to be charged. The suppler travels to the location and performs the charging and any other services requested. For example, the customer can summon a charger (provider) through the app for a designated time and location. The supplier is provided a make model, year, GPS coordinate for your vehicle. The supplier can dispatch a charger vehicle with the applicable equipment for charging the electric vehicle. The make, model, year, GPS coordinates may be automatically provided by the app or pre-input for the app to provide. In an example of the present invention, providers may be made available at large gatherings such as carnivals, fairs, or church gatherings. The providers will be available at those times to charge the electric vehicles. In some embodiments, registered customers may request a charge at any place/anytime.

While this process is generally described with reference to charging a vehicle, the process can also be utilized for providing portable power services for other application, for example, temporary power supply to a structure, (e.g., house, hospital etc.), temporary power supply to devices (e.g., traffic signals, communications substations, etc.), and the like.

As illustrated in FIG. 4, to request charging services, the user device can transmit a charging request 402 to the charge broker system 102. The charging request 402 can identify the user device 122, the user 120, the charging target 150, and the type of charging services requested. The charging request 402 can also include a geographic location of the charging target 150. Once received, the charge broker system 102 can transmit, for example, broadcast, a supplier request 404 to one or more supplier devices 112.

The supplier device 112, which desires to provide the charging services, can transmit a supplier acceptance 406 to charge broker system 102. The supplier acceptance 406 can include the terms of providing the charging services, e.g., cost, time frame, etc. The charge broker system 102 can transmit an acceptance notification 408 to the user device 122. In some embodiments, the acceptance notification 408 can require an acceptance response from the user device 122.

After acceptance, the supplier 110 can dispatch a charging vehicle to the geographic location identified by the charging request. Once the charging vehicle has arrived, the supplier device 112 can transmit an arrival notification 410. The arrival notification 410 can be sent to the user device 122 directly and/or via the charge broker system 102.

Once received, the user device 122 can generate and transmit a one-time access token 412 that allows the charging vehicle to access the charging target 150. The one-time access token 412 can be transmitted directly to the supplier device 112 and/or via the charge broker system 102. The one-time access token 412 can be a passcode and/or cryptographic token that enables access to the charging target 150. For example, the one-time access token 412 can be a passcode and/or cryptographic token that access an electric car. The supplier device 112 can utilize the one-time access token 412 to access the charging target and begin providing the charging services.

As the charge 414 is being provided, a status 416 of the charging service can be monitored. For example, the status 416 can be a charge level of the target 150. In another example, the status 416 can include an amount of time of the charging services. The status 416 can be transmitted to the user device 122. The status 416 can be transmitted by the charging target 150, the supplier device 112, and/or the charge broker system 102. In embodiments, the charging services can be performed for a period of time, to a particular charge level, and/or until a stop charging services message is received from the user device 122 and/or the charge broker system 102.

Once charging is complete, the supplier device 112 can transmit a charge complete message 420 to the charge broker system 102. The charge broker system 102 can transmit a charge summary 422 to the user device 122. In response, the user device 122 can initiate user settlement 424. For example, the user device 122 can initiate payment for the charging services. Then, the charge broker system 102 can initiate supplier settlement 426. For example, the charge broker system 102 can initiate payment for the charging services.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method for delivering portable charging, comprising:
receiving a charging request for a user device;
broadcasting a supplier request to a plurality of supplier devices;
receiving a supplier acceptance from a supplier device from the plurality of supplier devices;
transmitting an acceptance notification to the user device;
generating a one-time access token, wherein the one-time access token provides access to a charging target during a charging service; and
providing the one-time access token to the supplier device.

2. The method of claim 1, further comprising:
receiving a charge complete message from the supplier device;
providing a charge summary to the user device, wherein the charge summary comprises details of the charging service and a cost of the charging service; and
performing settlement of the cost of the charging service with the user device and the supplier device.

3. The method of claim 1, further comprising:
periodically transmitting a status during the charging service.

4. The method of claim 1, wherein the one-time access token expires based on a condition comprising at one or more of transmitting an acceptance notification; a cancelation request from the user device; and an expiration of a predetermined time period.

5. The method of claim 1, wherein the charging target comprises an electric vehicle.

6. The method of claim 1, further comprising:
registering the user device prior to the charging service.

7. The method of claim 1, further comprising:
registering the supplier device prior to the charging service.

8. The method of claim 1, wherein the supplier request comprises a geographic location of the charging target.

9. A computer-readable medium storing instructions that cause one or more processors to perform a method for delivering portable charging, the method comprising:
receiving a charging request for a user device;
broadcasting a supplier request to a plurality of supplier devices;
receiving a supplier acceptance from a supplier device from the plurality of supplier devices;
transmitting an acceptance notification to the user device;
generating a one-time access token, wherein the one-time access token provides access to a charging target during a charging service; and
providing the one-time access token to the supplier device.

10. A system for delivering portable charging, comprising:
a communication device for communicating with a user device and a plurality of supplier devices via one or more networks;
a memory device storing instructions; and
a processing device configured to execute the instructions to perform a method comprising:
receiving a charging request for the user device;
broadcasting a supplier request to the plurality of supplier devices;
receiving a supplier acceptance from a supplier device from the plurality of supplier devices;
transmitting an acceptance notification to the user device;
generating a one-time access token, wherein the one-time access token provides access to a charging target during a charging service; and
providing the one-time access token to the supplier device.
